(19) United States
(12) Patent Application Publication
(10) Pub. No.: US 2021/0354723 A1
(43) Pub. Date: Nov. 18, 2021

(54) DETERMINING PUDDLE SEVERITY FOR AUTONOMOUS VEHICLES

(71) Applicant: Waymo LLC, Mountain View, CA (US)

(72) Inventors: Courtney McCool, San Jose, CA (US); Roshni Cooper, Cupertino, CA (US); Timothy Yang, Redwood City, CA (US); Yuchi Wang, Ann Arbor, MI (US)

(21) Appl. No.: 16/872,502

(22) Filed: May 12, 2020

(51) Int. Cl. B60W 60/00; G06K 9/00; G06K 9/62

(52) U.S. Cl. CPC B60W 60/0011; B60W 60/0027; G06K 9/6267; G06K 9/00791

(57) ABSTRACT

Aspects of the disclosure provide methods for controlling a first vehicle having an autonomous driving mode. In one instance, sensor data generated by one or more sensors of the first vehicle may be received. A splash and characteristics of the splash may be detected from the sensor data using a classifier. A severity of a puddle may be determined based on the characteristics of the splash and a speed of a second vehicle that caused the splash. The first vehicle may be controlled based on the severity. In another instance, a location of a puddle relative to a tire of a second vehicle is estimated using sensor data generated by one or more sensors of the first vehicle. A severity of the puddle may be determined based on the estimated location. The first vehicle may be controlled based on the severity.

### BACKGROUND

Autonomous vehicles, for instance, vehicles that do not require a human driver, can be used to aid in the transport of passengers or items from one location to another. Such vehicles may operate in a fully autonomous mode where passengers may provide some initial input, such as a pickup or destination location, and the vehicle maneuvers itself to that location. Autonomous vehicles are equipped with various types of sensors in order to detect objects in the surroundings. For example, autonomous vehicles may include sonar, radar, camera, LIDAR, and other devices that scan and record data from the vehicle's surroundings.

### BRIEF DESCRIPTION OF THE DRAWINGS

FIG. 1 is a functional diagram of an example vehicle in accordance with an exemplary embodiment.

FIG. 2 is an example of map information in accordance with aspects of the disclosure.

FIG. 3 is an example diagram of a vehicle in accordance with aspects of the disclosure.

FIG. 4 is an example pictorial diagram of a system in accordance with aspects of the disclosure.

FIG. 5 is an example functional diagram of a system in accordance with aspects of the disclosure.

FIG. 6 is an example of a vehicle driving on a roadway in accordance with aspects of the disclosure.

FIG. 7 is an example flow diagram in accordance with aspects of the disclosure.

FIG. 8 is an example view of a portion of a vehicle and a puddle in accordance with aspects of the disclosure.

FIG. 9 is an example flow diagram in accordance with aspects of the disclosure.

FIG. 10 is an example view of a portion of a vehicle and a puddle in accordance with aspects of the disclosure.

### SUMMARY

Aspects of the disclosure provide a method for controlling a first vehicle having an autonomous driving mode. The method includes receiving, by one or more processors, sensor data generated by one or more sensors of the first vehicle; detecting, by one or more processors, a splash and characteristics of the splash from the sensor data using a classifier; determining, by one or more processors, severity of a puddle based on the characteristics of the splash and a speed of a second vehicle that caused the splash; and controlling, by one or more processors, the first vehicle based on the severity.

In one example, the severity corresponds to depth of the puddle where the splash was made. In another example, the characteristics of the splash include dimensions of the splash. In another example, the characteristics of the splash include an estimated volume of water over a period of time during the splash. In another example, determining the severity is further based on a size of the second vehicle. In another example, the method also includes, prior to determining the severity, selecting the classifier from a plurality of options for determining puddle severity based on the speed of the second vehicle. In another example, controlling the first vehicle includes controlling the first vehicle through the puddle. In another example, controlling the first vehicle includes controlling the first vehicle to avoid the puddle. In another example, controlling the first vehicle includes controlling the vehicle in order to avoid splashing the one or more sensors of the first vehicle. In another example, controlling the first vehicle includes controlling the vehicle in order to avoid splashing another road user. In this example, the another road user is a third vehicle. Alternatively, the another road user is a pedestrian. In another example, the method also includes, prior to detecting the splash, detecting a puddle, and wherein detecting the splash is in response to the detection of the puddle. In another example, the method also includes, sending the severity to a remote computing device. In another example, the severity corresponds to a severity value for at least one of a severity to the first vehicle, a severity to an object in the first vehicle's environment, or a severity to a passenger of the first vehicle.

Another aspect of the disclosure provides a method for controlling a first vehicle having an autonomous driving mode. The method includes receiving, by one or more processors, sensor data generated by one or more sensors of the first vehicle; estimating, by the one or more processors, a location of a puddle relative to a tire of a second vehicle; determining, by the one or more processors, severity of the puddle based on the estimated location; and controlling, by the one or more processors, the first vehicle based on the severity.

In one example, the method also includes, prior to estimating the severity of6 the puddle, determining the speed of the second vehicle, and wherein estimating the severity is in response to the determined speed. In another example, the severity corresponds to a depth of the puddle. In another example, estimating the severity of the puddle includes determining whether the tire is submerged in the puddle beyond a threshold depth. In another example, estimating the location of a puddle relative to a tire of the second vehicle is further based on at least one of size or shape of the second vehicle. cl DETAILED DESCRIPTION

### Overview

The technology relates to estimating the depth of puddles for autonomous vehicles. When another road user such as another vehicle passes through a puddle, the autonomous vehicle's perception system may generate temporary or transient LIDAR returns from the water kicked up by the other vehicle in the form of rooster tails, general road spray or splashes. The transient returns could be a source of information for estimating road wetness or puddle depth before they are filtered for use with other systems of the vehicle.

For instance, the size of the splash (e.g. dimensions such as height) may be mainly a function of vehicle speed, vehicle size, and puddle depth. In other words, the higher the speed and larger the vehicle, the greater the splash. As such, a classifier that detects splashes as well as their size could be used in conjunction with the characteristics of a puddle and vehicle speed for estimation of puddle depth or puddle severity.

This approach may be especially useful at higher speeds, e.g. speeds great enough to cause large, readily observable splashes. However, when vehicles are driving at low speeds, not much of a splash may be produced. For such situations, another classifier may be trained to identify the center of tires of other vehicles, for instance using computer vision approaches, and the classifier could be used to determine where the top of the puddle is located relative to the tire. The location relative to the tire may be estimated using a default model of a tire or by processing an image of the tire to determine how much of the curvature of the tire is visible in the image. If the tire is determined to be submerged beyond a threshold, a severity or depth estimation can be assigned to an observed puddle. In some instances, the classifier may be more advanced and may even take into account the size and shape of different vehicles when determining the location of the top of the puddle relative to the tire.

When there are no other vehicles around to generate splashes, the height of the laser points can be compared to the expected height of the road surface based on the elevation map. The difference can be used to estimate puddle depth and/or severity. Each of the aforementioned approaches can be used continuously or only during or after precipitation events. Once a puddle is detected and its depth estimated, such information may be used to control the vehicle.

The features described herein may provide for a useful way to detect the depth and also severity of puddles. Being able to route around deep puddles can reduce likelihood that the vehicle encounters a loss of friction, unexpected pothole, mechanical issue due to excessive water exposure (stalling), splashes its own sensors, etc. In addition, the vehicle may be able to prevent itself from being splashed by another vehicle or from splashing another road user such as a pedestrian, etc.

### Example Systems

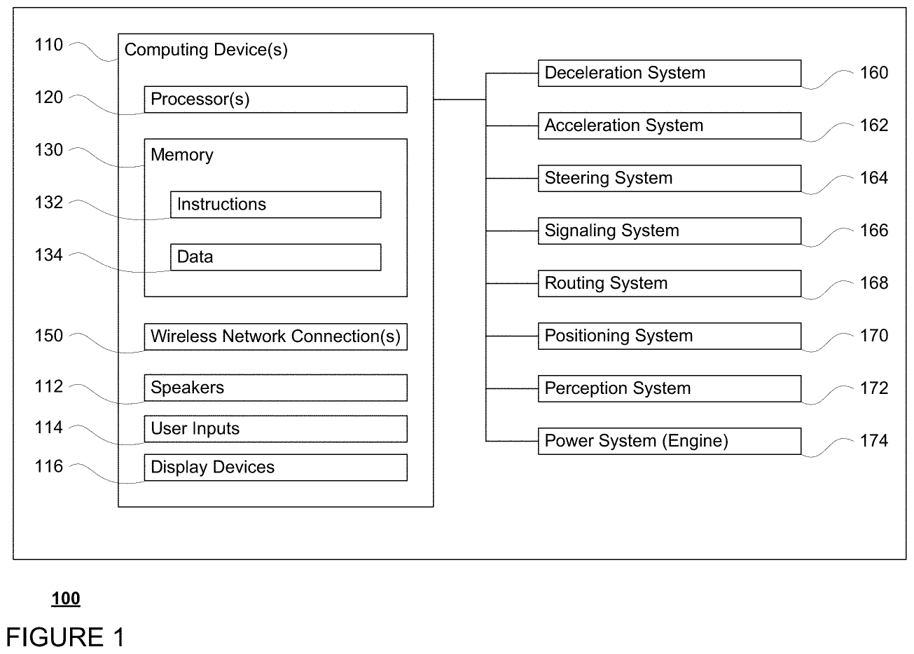

As shown in FIG. 1, a vehicle 100 in accordance with one aspect of the disclosure includes various components. While certain aspects of the disclosure are particularly useful in connection with specific types of vehicles, the vehicle may be any type of vehicle including, but not limited to, cars, trucks, motorcycles, buses, recreational vehicles, etc. The vehicle may have one or more computing devices, such as computing device 110 containing one or more processors 120, memory 130 and other components typically present in general purpose computing devices.

The memory 130 stores information accessible by the one or more processors 120, including instructions 132 and data 134 that may be executed or otherwise used by the processor 120. The memory 130 may be of any type capable of storing information accessible by the processor, including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 132 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The data 134 may be retrieved, stored or modified by processor 120 in accordance with the instructions 132. For instance, although the claimed subject matter is not limited by any particular data structure, the data may be stored in computing device registers, in a relational database as a table having a plurality of different fields and records, XML documents or flat files. The data may also be formatted in any computing device-readable format.

The one or more processor 120 may be any conventional processors, such as commercially available CPUs or GPUs. Alternatively, the one or more processors may be a dedicated device such as an ASIC or other hardware-based processor. Although FIG. 1 functionally illustrates the processor, memory, and other elements of computing device 110 as being within the same block, it will be understood by those of ordinary skill in the art that the processor, computing device, or memory may actually include multiple processors, computing devices, or memories that may or may not be stored within the same physical housing. For example, memory may be a hard drive or other storage media located in a housing different from that of computing device 110. Accordingly, references to a processor or computing device will be understood to include references to a collection of processors or computing devices or memories that may or may not operate in parallel.

The computing devices 110 may also be connected to one or more speakers 112, user inputs 114, and display devices 116. The user input may include a button, touchscreen, or other devices that may enable an occupant of the vehicle, such as a driver or passenger, to provide input to the computing devices 110 as described herein. For example, a passenger may be able to provide information about a puddle as discussed further below. The display devices 116 may include any number of different types of displays including monitors, touchscreens or other devices that may enable the vehicle to provide information to or request information from a passenger.

In one aspect the computing devices 110 may be part of an autonomous control system capable of communicating with various components of the vehicle in order to control the vehicle in an autonomous driving mode. For example, returning to FIG. 1, the computing devices 110 may be in communication with various systems of vehicle 100, such as deceleration system 160, acceleration system 162, steering system 164, routing system 166, planning system 168, positioning system 170, and perception system 172 in order to control the movement, speed, etc. of vehicle 100 in accordance with the instructions 132 of memory 130 in the autonomous driving mode. In this regard, each of these systems may be one or more processors, memory, data and instructions. Such processors, memories, instructions and data may be configured similarly to one or more processors 120, memory 130, instructions 132, and data 134 of computing device 110.

As an example, computing devices 110 may interact with deceleration system 160 and acceleration system 162 in order to control the speed of the vehicle. Similarly, steering system 164 may be used by computing devices 110 in order to control the direction of vehicle 100. For example, if vehicle 100 is configured for use on a road, such as a car or truck, the steering system may include components to control the angle of wheels to turn the vehicle.

Planning system 168 may be used by computing devices 110 in order to determine and follow a route generated by a routing system 166 to a location. For instance, the routing system 166 may use map information to determine a route from a current location of the vehicle to a drop off location. The planning system 168 may periodically generate trajectories, or short-term plans for controlling the vehicle for some period of time into the future, in order to follow the route (a current route of the vehicle) to the destination. In this regard, the planning system 168, routing system 166, and/or data 134 may store detailed map information, e.g., highly detailed maps identifying the shape and elevation of roadways, lane lines, intersections, crosswalks, speed limits, traffic signals, buildings, signs, real time traffic information, vegetation, or other such objects and information. In addition, the map information may identify area types such as constructions zones, school zones, residential areas, parking lots, etc.

The map information may include one or more roadgraphs or graph networks of information such as roads, lanes, intersections, and the connections between these features which may be represented by road segments. Each feature may be stored as graph data and may be associated with information such as a geographic location and whether or not it is linked to other related features, for example, a stop sign may be linked to a road and an intersection, etc. In some examples, the associated data may include grid-based indices of a roadgraph to allow for efficient lookup of certain roadgraph features.

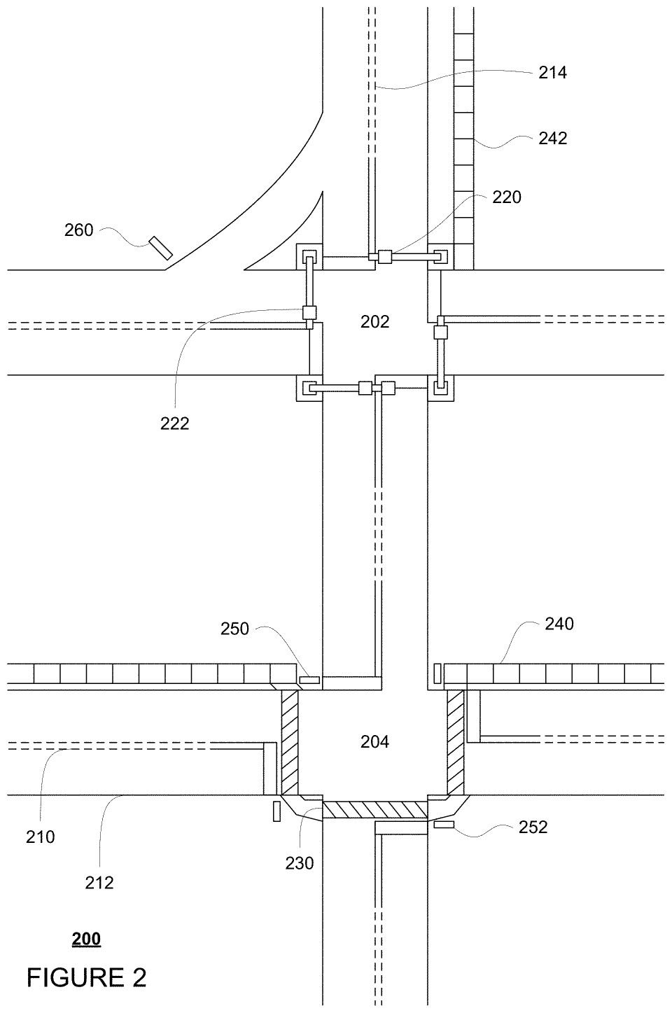

FIG. 2 is an example of map information 200 for a section of roadway including intersections 202, 204. The map information 200 may be a local version of the map information stored in the memory 130 of the computing devices 110. Other versions of the map information may also be stored in the storage system 450 discussed further below. In this example, the map information 200 includes information identifying the shape, location, and other characteristics of lane lines 210, 212, 214, traffic lights 220, 222, crosswalk 230, sidewalks 240, 242, stop signs 250, 252, and yield sign 260. In this regard, the map information includes the three-dimensional (3D) locations of traffic lights 220, 222 as well as information identifying the lanes which are controlled by these traffic lights.

While the map information is depicted herein as an image-based map, the map information need not be entirely image based (for example, raster). For example, the map information may include one or more roadgraphs or graph networks of information such as roads, lanes, intersections, and the connections between these features which may be represented by road segments. Each feature may be stored as graph data and may be associated with information such as a geographic location and whether or not it is linked to other related features, for example, a stop sign may be linked to a road and an intersection, etc. In some examples, the associated data may include grid-based indices of a roadgraph to allow for efficient lookup of certain roadgraph features.

Positioning system 170 may be used by computing devices 110 in order to determine the vehicle's relative or absolute position on a map and/or on the earth. The positioning system 170 may also include a GPS receiver to determine the device's latitude, longitude and/or altitude position relative to the Earth. Other location systems such as laser-based localization systems, inertial-aided GPS, or camera-based localization may also be used to identify the location of the vehicle. The location of the vehicle may include an absolute geographical location, such as latitude, longitude, and altitude as well as relative location information, such as location relative to other cars immediately around it which can often be determined with less noise than absolute geographical location.

The positioning system 170 may also include other devices in communication with the computing devices of the computing devices 110, such as an accelerometer, gyroscope or another direction/speed detection device to determine the direction and speed of the vehicle or changes thereto. By way of example only, an acceleration device may determine its pitch, yaw or roll (or changes thereto) relative to the direction of gravity or a plane perpendicular thereto. The device may also track increases or decreases in speed and the direction of such changes. The device's provision of location and orientation data as set forth herein may be provided automatically to the computing device 110, other computing devices and combinations of the foregoing.

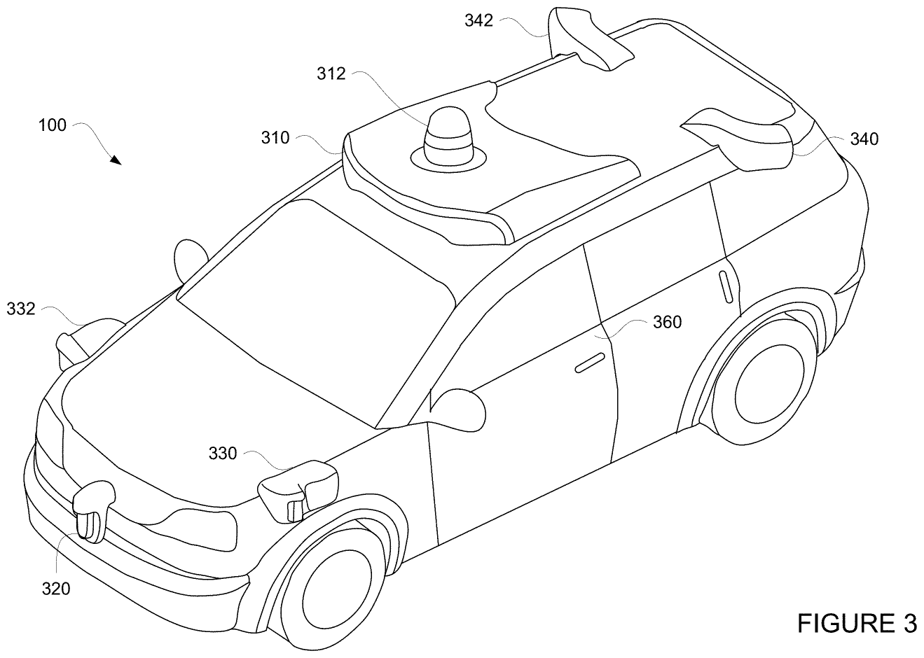

The perception system 172 also includes one or more components for detecting objects external to the vehicle such as other vehicles, obstacles in the roadway, traffic signals, signs, trees, etc. For example, the perception system 172 may include lasers, sonar, radar, cameras and/or any other detection devices that record data which may be processed by the computing devices of the computing devices 110. In the case where the vehicle is a passenger vehicle such as a minivan, the minivan may include a laser or other sensors mounted on the roof or other convenient location. For instance, FIG. 3 is an example external view of vehicle 100. In this example, roof-top housing 310 and dome housing 312 may include a LIDAR sensor as well as various cameras and radar units. In addition, housing 320 located at the front end of vehicle 100 and housings 330, 332 on the driver's and passenger's sides of the vehicle may each store a LIDAR sensor. For example, housing 330 is located in front of driver door 360. Vehicle 100 also includes housings 340, 342 for radar units and/or cameras also located on the roof of vehicle 100. Additional radar units and cameras (not shown) may be located at the front and rear ends of vehicle 100 and/or on other positions along the roof or roof-top housing 310.

The computing devices 110 may be capable of communicating with various components of the vehicle in order to control the movement of vehicle 100 according to primary vehicle control code of memory of the computing devices 110. For example, returning to FIG. 1, the computing devices 110 may include various computing devices in communication with various systems of vehicle 100, such as deceleration system 160, acceleration system 162, steering system 164, routing system 166, planning system 168, positioning system 170, perception system 172, and power system 174 (i.e. the vehicle's engine or motor) in order to control the movement, speed, etc. of vehicle 100 in accordance with the instructions 132 of memory 130.

The various systems of the vehicle may function using autonomous vehicle control software in order to determine how to and to control the vehicle. As an example, a perception system software module of the perception system 172 may use sensor data generated by one or more sensors of an autonomous vehicle, such as cameras, LIDAR sensors, radar units, sonar units, etc., to detect and identify objects and their features. These features may include location, type, heading, orientation, speed, acceleration, change in acceleration, size, shape, etc. In some instances, features may be input into a behavior prediction system software module which uses various behavior models based on object type to output a predicted future behavior for a detected object.

In other instances, the features may be put into one or more detection system software modules, such as a traffic light detection system software module configured to detect the states of known traffic signals, a school bus detection system software module configured to detect school busses, construction zone detection system software module configured to detect construction zones, a detection system software module configured to detect one or more persons (e.g. pedestrians) directing traffic, a traffic accident detection system software module configured to detect a traffic accident, an emergency vehicle detection system configured to detect emergency vehicles, etc. Each of these detection system software modules may input sensor data generated by the perception system 172 and/or one or more sensors (and in some instances, map information for an area around the vehicle) into various models which may output a likelihood of a certain traffic light state, a likelihood of an object being a school bus, an area of a construction zone, a likelihood of an object being a person directing traffic, an area of a traffic accident, a likelihood of an object being an emergency vehicle, etc., respectively.

Detected objects, predicted future behaviors, various likelihoods from detection system software modules, the map information identifying the vehicle's environment, position information from the positioning system 170 identifying the location and orientation of the vehicle, a destination for the vehicle as well as feedback from various other systems of the vehicle may be input into a planning system software module of the planning system 168. The planning system may use this input to generate trajectories for the vehicle to follow for some brief period of time into the future based on a current route of the vehicle generated by a routing module of the routing system 166. A control system software module of the computing devices 110 may be configured to control movement of the vehicle, for instance by controlling braking, acceleration and steering of the vehicle, in order to follow a trajectory.

Computing devices 110 may also include one or more wireless network connections 150 to facilitate communication with other computing devices, such as the client computing devices and server computing devices described in detail below. The wireless network connections may include short range communication protocols such as Bluetooth, Bluetooth low energy (LE), cellular connections, as well as various configurations and protocols including the Internet, World Wide Web, intranets, virtual private networks, wide area networks, local networks, private networks using communication protocols proprietary to one or more companies, Ethernet, WiFi and HTTP, and various combinations of the foregoing.

The computing devices 110 may control the vehicle in an autonomous driving mode by controlling various components. For instance, by way of example, the computing devices 110 may navigate the vehicle to a destination location completely autonomously using data from the detailed map information and planning system 168. The computing devices 110 may use the positioning system 170 to determine the vehicle's location and perception system 172 to detect and respond to objects when needed to reach the location safely. Again, in order to do so, computing device 110 may generate trajectories and cause the vehicle to follow these trajectories, for instance, by causing the vehicle to accelerate (e.g., by supplying fuel or other energy to the engine or power system 174 by acceleration system 162), decelerate (e.g., by decreasing the fuel supplied to the engine or power system 174, changing gears, and/or by applying brakes by deceleration system 160), change direction (e.g., by turning the front or rear wheels of vehicle 100 by steering system 164), and signal such changes (e.g. by using turn signals). Thus, the acceleration system 162 and deceleration system 160 may be a part of a drivetrain that includes various components between an engine of the vehicle and the wheels of the vehicle. Again, by controlling these systems, computing devices 110 may also control the drivetrain of the vehicle in order to maneuver the vehicle autonomously.

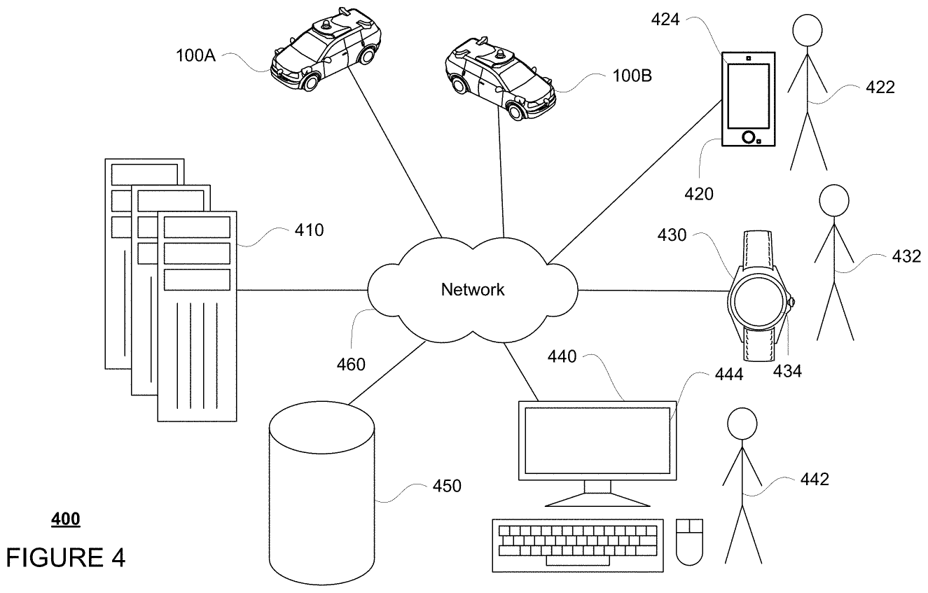

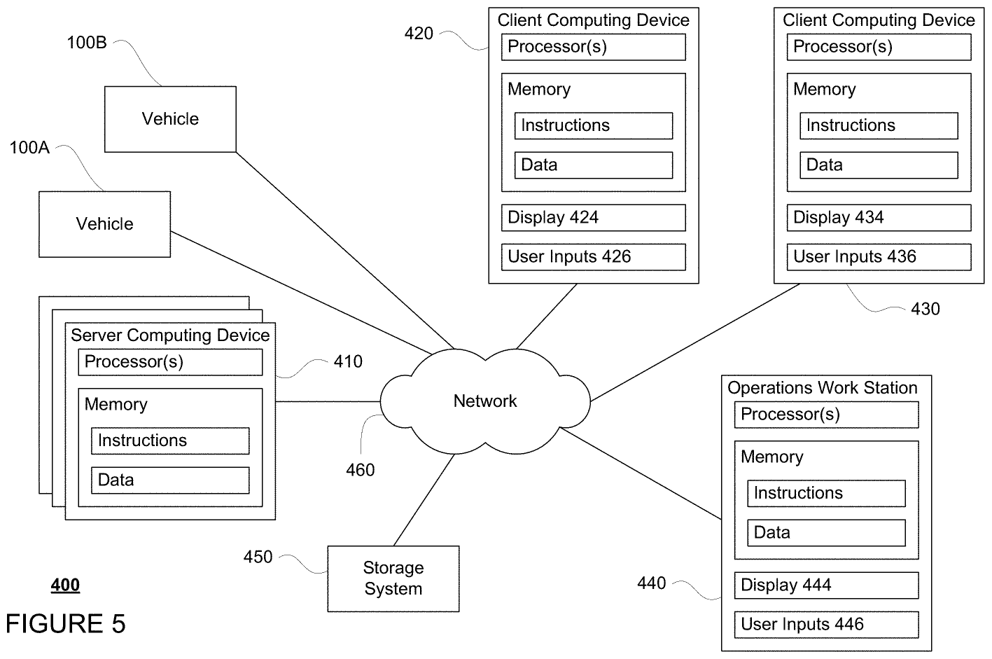

Computing device 110 of vehicle 100 may also receive or transfer information to and from other computing devices, such as those computing devices that are a part of the transportation service as well as other computing devices. FIGS. 4 and 5 are pictorial and functional diagrams, respectively, of an example system 400 that includes a plurality of computing devices 410, 420, 430, 440 and a storage system 450 connected via a network 460. System 400 also includes vehicle 100, and vehicles 100A, 100B which may be configured the same as or similarly to vehicle 100. Although only a few vehicles and computing devices are depicted for simplicity, a typical system may include significantly more.

As shown in FIG. 4, each of computing devices 410, 420, 430, 440 may include one or more processors, memory, instructions and data. Such processors, memories, data and instructions may be configured similarly to one or more processors 120, memory 130, instructions 132 and data 134 of computing device 110.

The network 460, and intervening nodes, may include various configurations and protocols including short range communication protocols such as Bluetooth, Bluetooth LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, one or more computing devices 410 may include one or more server computing devices having a plurality of computing devices, e.g., a load balanced server farm, that exchange information with different nodes of a network for the purpose of receiving, processing and transmitting the data to and from other computing devices. For instance, one or more computing devices 410 may include one or more server computing devices that are capable of communicating with computing device 110 of vehicle 100 or a similar computing device of vehicle 100A as well as computing devices 420, 430, 440 via the network 460. For example, vehicles 100, 100A, may be a part of a fleet of vehicles that can be dispatched by server computing devices to various locations. In this regard, the server computing devices 410 may function as a validation computing system which can be used to validate autonomous control software which vehicles such as vehicle 100 and vehicle 100A may use to operate in an autonomous driving mode. In addition, server computing devices 410 may use network 460 to transmit and present information to a user, such as user 422, 432, 442 on a display, such as displays 424, 434, 444 of computing devices 420, 430, 440. In this regard, computing devices 420, 430, 440 may be considered client computing devices.

As shown in FIG. 4, each client computing device 420, 430, 440 may be a personal computing device intended for use by a user 422, 432, 442, and have all of the components normally used in connection with a personal computing device including a one or more processors (e.g., a central processing unit (CPU)), memory (e.g., RAM and internal hard drives) storing data and instructions, a display such as displays 424, 434, 444 (e.g., a monitor having a screen, a touch-screen, a projector, a television, or other device that is operable to display information), and user input devices 426, 436, 446 (e.g., a mouse, keyboard, touchscreen or microphone). The client computing devices may also include a camera for recording video streams, speakers, a network interface device, and all of the components used for connecting these elements to one another.

Although the client computing devices 420, 430, and 440 may each comprise a full-sized personal computing device, they may alternatively comprise mobile computing devices capable of wirelessly exchanging data with a server over a network such as the Internet. By way of example only, client computing device 420 may be a mobile phone or a device such as a wireless-enabled PDA, a tablet PC, a wearable computing device or system, or a netbook that is capable of obtaining information via the Internet or other networks. In another example, client computing device 430 may be a wearable computing system, shown as a wristwatch as shown in FIG. 4. As an example the user may input information using a small keyboard, a keypad, microphone, using visual signals with a camera, or a touch screen.

In some examples, client computing device 440 may be an operations workstation used by a human labeler, an administrator or other operator. Although only a single operations workstation 440 is shown in FIGS. 4 and 5, any number of such work stations may be included in a typical system. Moreover, although operations workstation is depicted as a desktop computer, operations work stations may include various types of personal computing devices such as laptops, netbooks, tablet computers, etc.

As with memory 130, storage system 450 can be of any type of computerized storage capable of storing information accessible by the server computing devices 410, such as a hard-drive, memory card, ROM, RAM, DVD, CD-ROM, write-capable, and read-only memories. In addition, storage system 450 may include a distributed storage system where data is stored on a plurality of different storage devices which may be physically located at the same or different geographic locations. Storage system 450 may be connected to the computing devices via the network 460 as shown in FIGS. 4 and 5, and/or may be directly connected to or incorporated into any of the computing devices 110, 410, 420, 430, 440, etc.

Storage system 450 may store various types of information as described in more detail below. For example, the storage system 450 may store various classifiers or machine learning models such as neural networks, decision trees, etc. for detecting and identifying various features in a vehicle's environment including puddles, splashes, wet roads, as well as characteristics of those puddles and splashes as discussed further below.

As another example, storage system 450 may store log data generated by a vehicle, such as vehicle 100, when operating in the autonomous driving mode or other driving modes. In this regard, the log data may identify certain events experienced by the vehicle and logged by the computing devices 110, such as swerving, hydroplaning, etc. The log data may also include information output by various systems of the vehicle described herein as well as information input by an occupant of the vehicle, for example, regarding puddles as described herein. The log data may also include sensor data, such as LIDAR sensor data points, camera images, etc., generated by sensors of a perception system of vehicles of the fleet of vehicles (e.g. vehicles 100A and 100B). This sensor data may include information identifying other objects such as the location, size and speed of other vehicles.

At least some of this log data may be associated with labels. Some of these labels may include information identifying the aforementioned other objects, such as other vehicles, as well as their characteristics, such as the location, size and speed. At least some of these labels may be provided by human operators identifying the length, width and position of puddles. For instance, human operators may label the location of puddles in images by reviewing the images and drawing bounding boxes around the puddle. These labels may be used to train a classifier for detecting and identifying puddles and their characteristics (e.g. shape, length, width, position, etc.). Others of the labels may be provided by human operators identifying characteristics of splashes such as the maximum height of the splash, the density of LIDAR sensor data points directly behind a tire and/or adjacent to the tire of another vehicle that caused the splash, as well as the duration of the splash or the period of time between when the splash “starts” and “ends”. These and other labels discussed further below may be used to train various classifiers for detecting and identifying splashes and their characteristics as discussed further below.

### Example Methods

In addition to the operations described above and illustrated in the figures, various operations will now be described. It should be understood that the following operations do not have to be performed in the precise order described below. Rather, various steps can be handled in a different order or simultaneously, and steps may also be added or omitted.

Depending upon the current driving situation, different approaches can be used by the computing devices 110 of the vehicle 100 to determine the severity of puddles. Each of these approaches can be used continuously or only during or after precipitation events. For example different approaches can be used when another vehicle causes a splash in a puddle or when another vehicle does not cause a splash in a puddle. In addition, depending upon the speed of a vehicle passing through a puddle, different approaches can be used as discussed further below. In this regard, the vehicle's computing devices may actually select between ones of the approaches depending upon the current driving situation as discussed further below. In some instances, these approaches may be combined to better estimate puddle depth or severity.

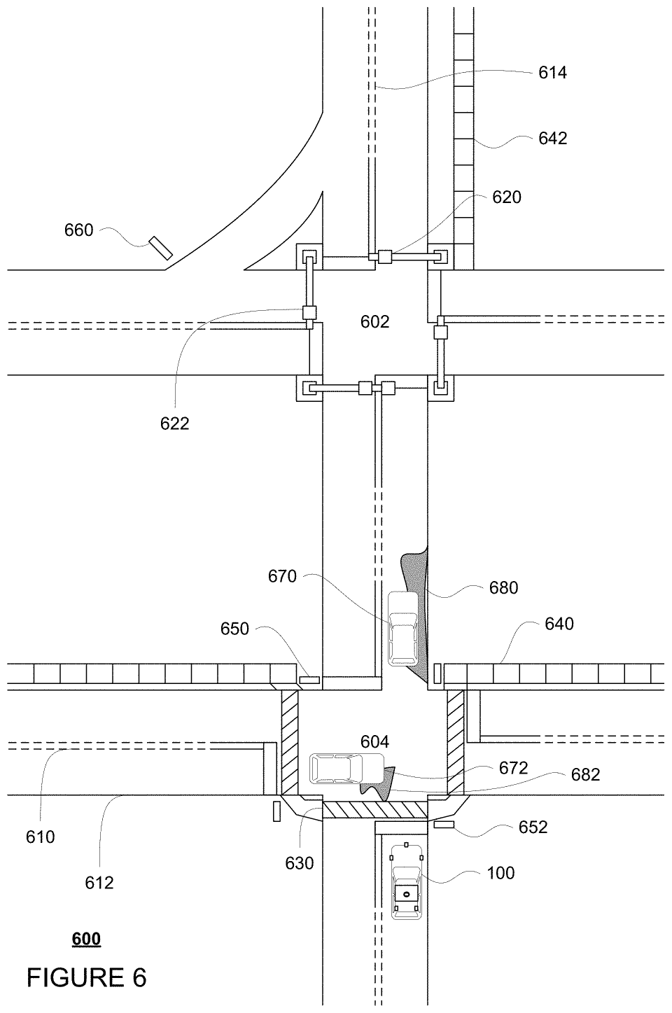

FIG. 6 provides an example of vehicle 100 driving on a section of roadway 600 corresponding to the area of map information 200. In this regard, the shape, location and other characteristics of intersections 602, 604 correspond to the shape, location and other characteristics of intersections 202, 204. Similarly, the shape, location, and other characteristics of lane lines 610, 612, 614, traffic lights 620, 622, crosswalk 630, sidewalks 640, 642, stop signs 650, 652, and yield sign 660, correspond to the shape, location, and other characteristics of lane lines 210, 212, 214, traffic lights 220, 222, crosswalk 230, sidewalks 240, 242, stop signs 250, 252, and yield sign 260, respectively.

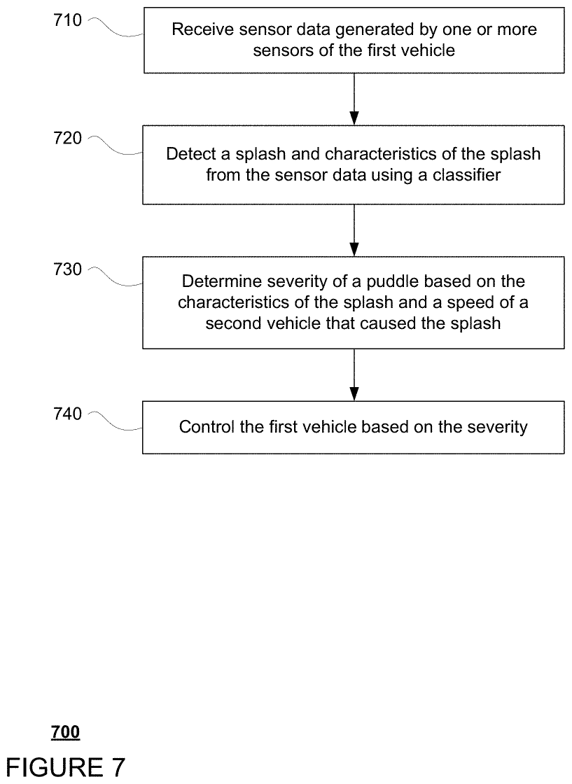

FIG. 7 includes an example flow diagram 700 of some of the examples for controlling a first vehicle, such as vehicle 100, having an autonomous driving mode, which may be performed by one or more processors such as processors of computing devices 110 and/or processors of the positioning system 170. For instance, at block 710, sensor data generated by one or more sensors of the first vehicle is received. For example, the sensors of the perception system 172 may detect and identify objects in the vehicle's environment. Such objects may include the puddles 680, 682 and vehicles 670, 672 of FIG. 6.

Puddles or standing water may be detected using various techniques such as image classification techniques, reflectivity of LIDAR sensor data points, radar sensor data etc. For example, transmitted LIDAR signals that contact puddles may fail to reflect back to the sensor when the puddle is more than a certain distance from the sensor, such as 10 m, or more or less. Accordingly, a LIDAR sensor may produce little or no sensor data for locations where a puddle is present when the sensor is more than the certain distance from the puddle. The computing device 110 may determine that puddle is present in a location where no sensor data is present if the map information indicates a road surface is mapped at the location where no or little sensor data is present. The dimensions, for instance length and width, as well as an approximation of area, of the puddle may be determined by the computing device 110 from the received LIDAR signals and map information. In some instances, radar signals may be used by the computing devices to detect a puddle. For instance, a surface of a puddle may likely be in motion as the result of vibrations and wind, while road surfaces are typically stationary. In some instances, a classifier that detects wet roads can be used as a signal to increase the confidence in the detection of a puddle.

In addition or alternatively, a classifier may be used to determine whether an image captured by the vehicle's camera sensors includes a puddle. The model may include a classifier such as a neural network, a deep neural network, decision tree, boosting tree, etc. The training data for the model may be generated from the set of images in various ways. For instance, human operators may label the location of puddles in images by reviewing the images and drawing bounding boxes around the puddle. In addition or alternatively, existing models or image processing techniques may be used to label the location of puddles based on characteristics of puddles such as color, contrast, brightness, texture, etc. LIDAR signals, audio signals, and other such sensor data may also be used as training data. In some instances, the model may first be trained “offline” that is, ahead of time and/or at a remote computing device and thereafter sent and implemented at the vehicle. Given an image of a roadway including puddle, which may be considered a training input, and labels indicating puddle and the location of the puddle, which may be considered training outputs, the model may be trained to detect puddle and output the location of puddle found in a captured image. In this regard, training inputs and training outputs may be example inputs and outputs for the model used for training. Again, as noted above, another classifier that detects wet roads can be used as a signal to increase the confidence in the identification of a puddle by the model.

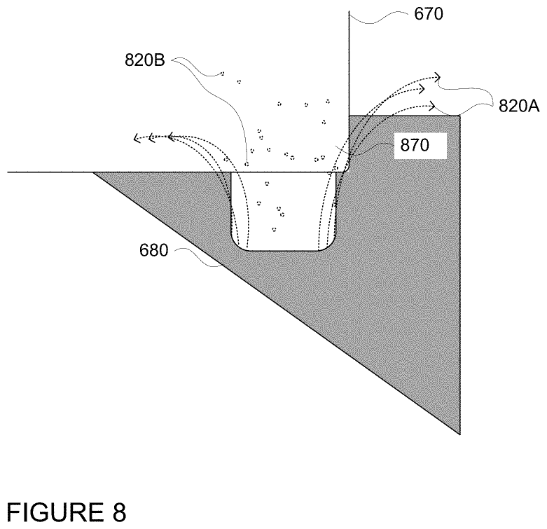

When another road user such as another vehicle passes through a puddle, the perception system 172 may generate temporary or transient LIDAR returns (e.g. LIDAR sensor data points) from the water kicked up by the other vehicle in the form of rooster tails, general road spray or splashes. These transient returns may be used as a source of information for estimating road wetness or puddle depth before they are filtered for use with other systems of the vehicle. FIG. 8 depicts a detail view of an example of a portion of vehicle 670 and puddle 680. In this example, the tire 870 of the vehicle 670 has caused a splash of liquid from the puddle to spray upward, outward and behind (rooster tail) the vehicle 670. The splash is represented by dashed lines and “droplets” 820A, 820B, respectively.

Returning to FIG. 7, at block 720 a splash and characteristics of the splash are detected from the sensor data using a first classifier. In order to do so, the first classifier may first be trained, for example, by one or more server computing devices, such as the server computing devices 410. Examples of training inputs may include the logged sensor data.

Examples of training outputs may include the aforementioned labels provided by human operators identifying characteristics of the splash such as the maximum height of the splash, the density of LIDAR sensor data points directly behind a tire and/or adjacent to the tire, the intensity and elongation of those LIDAR sensor data points, as well as duration of the splash or the period of time between when the splash “starts” and “ends”. In this regard, the first classifier may be a machine learning model that can be used to identify a splash as well as its characteristics given input sensor data. In this regard, the training may increase the precision of the classifier such that the more training data (input and output) used to train the classifier, the greater the precision of the classifier in detecting splashes and the characteristics of splashes. Once trained, the first classifier may be downloaded or otherwise provided to the computing devices 110 of the vehicle 100 in order to enable the computing devices to use the first classifier in real time to detect splashes and their characteristics.

Returning to FIG. 7, at block 730, severity of a puddle is determined based on the characteristics of the splash and a speed of a second vehicle that caused the splash. This determination may be made using a second classifier. In this regard, the output of the first classifier may be used as input to the second classifier if the first classifier detects a splash. In that regard, if the first classifier does not detect a splash, the second classifier need not be used.

Again, this second classifier may be trained, for example, by one or more server computing devices, such as the server computing devices 410, using various training inputs (e.g. example inputs and outputs for the model used for training). Examples of training inputs may include sensor data as well as labels corresponding to the information that would be generated by the first classifier such as the maximum height of the splash, the density of LIDAR sensor data points directly behind a tire and/or adjacent to the tire, as well as the period of time between when the splash “starts” and “ends”.

In some instances, the sensor data input into the second classifier for the purposes of training or use may be adjusted. For instance, the density of LIDAR sensor data points may be directly related to the distance of the splash from vehicle 100's sensors, and in addition, the uncertainty of predictions may be higher for splashes that occur farther away from vehicle 100's sensors. Examples of training outputs may include ground truth labeled data (e.g. sensor data labeled by human operators stored in storage system 450) which identify either the depth of a puddle or a severity of the puddle.

The training inputs may also include the location, size and speed of other vehicles. The volume of water may be expected to increase as vehicle speed, vehicle size, and puddle depth or severity increase. For instance, the size of the splash (e.g. dimensions such as height) may be mainly a function of vehicle speed, vehicle size, and puddle depth. In other words, the higher the speed and larger the vehicle, the greater the splash, with some exceptions (like vehicles which may include mud flaps or smaller tire wells). Larger tires and deeper puddles would mean a greater volume of displaced water. Faster vehicles would displace the same volume of water over a shorter amount of time, resulting in a higher velocity for the escaping fluid. Some tire treads may carry more water up, potentially spraying more into the air. Because the vehicle's perception system will also label the location, size and speed of other vehicles proximate to the splash location, this information may be included in the logged data stored in the storage system 450 and can also be used as training inputs.

The training outputs may also include human operator generated labels identifying the change in dimensions of splashes over time as well as severity values. The change in dimensions over time may be used to estimate the volume of water displaced over time by the splash or rather, the depth of the puddle and/or severity of the puddle. Thus, for the same speed and vehicle size, as the volume of water displaced increases, the depth of the puddle and/or severity of the puddle would also increase. The severity of a puddle may reflect how detrimental the puddle may be to the vehicle 100, to a passenger of the vehicle 100, as well as other objects in the vehicle 100's environment. Thus, the model could be trained to output for each puddle one severity value (e.g. related to the vehicle, a passenger, or other objects), multiple severity values for each puddle (e.g. one each for the vehicle, a passenger, or other objects), or could output the highest severity value (e.g. select from among severity values for the vehicle, a passenger, or other objects).

For the vehicle, puddles may cause spray which can temporarily occlude the vehicle 100's sensors. In such cases, human labelers may review sensor data and identify how severely the splash occludes the vehicle's sensors. Such severity values may be normalized to a scale of a predetermined range such as 0 to 1 or some other value and used as training outputs as noted above. As a similar example, human labelers may review sensor data and may draw outlines around splashes in camera images or LIDAR sensor data or identify what portion of LIDAR sensor data (i.e. which data points or returns) should be filtered or removed. If the vehicle that captured the sensor data is traveling at the same speed as the vehicle that caused the splash, the server computing devices could identify a similar “splash zone” around the tires of the vehicle that captured the sensor data. If a height of the splash zone height is above a height of the sensors of the vehicle's sensors, this may indicate a more severe puddle or greater severity values. Alternatively, human labeler may draw outlines around splashes in camera images or LIDAR sensor data. These outlines may be analyzed using structured testing to determine how different size splashes affect the ability of the computing devices 110 to control the vehicle. Again, such severity values may be normalized to some scale of some predetermined range of 0 to 1 or some other value and used as training outputs as noted above.

For the vehicle, puddles can also lead to hydroplaning where the vehicle's tires lose contact with the ground. In such cases, simulations can be run where human labelers identify how fast a vehicle can be driven through a puddle of a particular depth or how badly the vehicle might lose the ability to control the vehicle at a certain speed should the vehicle drive over a puddle. This can be converted to a severity value, such that when a human labeler identifies a lower speed, this would correspond to a higher severity value. Similarly, when a human labeler identifies a higher speed, this would correspond to a lower severity value. For example, hydroplaning is more likely to occur at higher vehicle speeds when water is deeper than 2.5 mm. Again, these severity values may be normalized to some scale of some predetermined range of 0 to 1 or some other value and used as training outputs as noted above.

For a passenger of the vehicle, during a ride, when a puddle, bump or hydroplaning event is detected, a passenger could ask to confirm whether the vehicle drove through a puddle or how driving through the puddle felt to the passenger (e.g. how uncomfortable), for instance, using the display devices 116 and user inputs 114. The response input by the passenger may be converted to a severity value which may be normalized to some scale of some predetermined range of 0 to 1 or some other value and used as training outputs as noted above. As another example, passengers of vehicles of the fleet could be asked to confirm whether a detected puddle is too deep for a drop off location, for instance using an application on a client computing device such as an application on a mobile phone. This may occur as the vehicle is approaching a puddle or after the passenger is dropped off Again, the response input by the passenger may be converted to a severity value which may be normalized to some scale of some predetermined range of 0 to 1 or some other value and used as training outputs as noted above. In addition, the information provided by a passenger can be analyzed with the information about the puddle, such as LIDAR data points, camera images, elevation map info, etc., and used to create a classifier to link the two.

For other object's in the vehicle's environment, human labelers may review sensor data and may draw outlines around splashes in camera images or LIDAR sensor data. If the vehicle that captured the sensor data is traveling at the same speed as the vehicle that caused the splash, the server computing devices could identify a similar “splash zone” around the tires of the vehicle that captured the sensor data. The larger this splash zone, the greater the impact on other objects, in the vehicle's environment and the greater the severity value. Again, these severity values may be normalized to some scale of some predetermined range of 0 to 1 or some other value and used as training outputs as noted above. As another example, human labelers may be asked to rate or identify severity values corresponding to the impact of puddles and/or splashes on other objects around the vehicle that caused the splash including other vehicles, bicyclists, and pedestrians. Such information may include, for example, how much other vehicles swerved, decelerated, etc. when approaching a puddle, to avoid a splash, or in response to being splashed. Again, these severity values may be normalized to some scale of some predetermined range of 0 to 1 or some other value and used as training outputs as noted above.

In this regard, the training may increase the precision of the classifier such that the more training data (input and output) used to train the classifier, the greater the precision of the classifier in determining the severity of a puddle as in any of the examples above. Once trained, the second classifier may be downloaded or otherwise provided to the computing devices 110 of the vehicle 100 in order to enable the computing devices to use the second classifier in real time to determine the severity of a puddle.

Alternatively, rather than using two distinct classifiers, a single classifier which uses the sensor data as well as labels for other objects (include the location, size and shape of other vehicles.) as input and outputs one or more severity values as described above may be used.

Returning to FIG. 7, at block 740, the vehicle is controlled based on the severity. Once a puddle is detected and its severity or depth estimated, such information may be used to control the vehicle. For instance, for deeper or more severe puddles, or rather, puddles with greater severity values, which may result in reduced friction with tires and make the desired motion of the vehicle more difficult, the vehicle can route around them, such as by changing lanes or taking another route. For more shallow or severe puddles, or rather, puddles with lower severity values, the computing devices 110 may control the vehicle in order to slow down prior to and/or while proceeding through the puddle. In addition, if the vehicle is going to pass through a puddle, the vehicle's computing devices 110 could turn on any cleaning capability to clear expected splash from sensors or other portions of the vehicle. For example, if the severity value corresponds to an expected “splash zone” that is at least as high as a sensor, in response, a cleaning capability could be activated for that sensor. Alternatively, a puddle with a high severity value that is identified from a large volume or long duration of a splash could indicate a lot of mist or spray in the air. In response, a cleaning capability could be activated. As such, the vehicle can effectively reduce the likelihood of splashing itself and dirtying or otherwise occluding its own sensors, being splashed by other vehicles, or even splashing other road users such as pedestrians. As another example, this information may be used to enable a vehicle to avoid stopping in deeper puddles for pickup and/or drop off of passengers.

The detection of a puddle and its severity or depth may also be used by other systems of the vehicle. For instance, the perception system 172 may filter out sensor data corresponding to splashes before publishing sensor data to various systems. Knowing a puddle's severity or depth would allow the perception system to determine how aggressively to filter LIDAR sensor data points. For example, a classifier that outputs a score from 0 to 1 for each LIDAR sensor data point being spurious, that is part of a splash, vapor, or other debris not relevant to controlling the vehicle 100. These scores may be compared to a threshold to determine which LIDAR sensor data points should be filtered. For example, as a default value, all points with scores above a threshold value of 0.85 or more or less may be filtered out. But splashes from puddles may create a lot of filterable points, and if there is a thick sheet of water coming up, a lot of the LIDAR sensor data points might have scores below the threshold value. As such, when the severity value of a puddle is high enough, the threshold value for filtering data points proximate to the puddle (to avoid filtering other LIDAR data points that should not be filtered) may be decreased, for example to 0.65 or more or less.

As another instance, the behavior prediction models may use the detection to make assumptions about how other vehicles on the road behave. For instance, behaviors may change in the presence of large/deep puddles. For example, sometimes vehicles may swerve or change lanes to avoid large puddles or may slow down dramatically after entering a puddle to avoid losing control. Additionally, pedestrians might be following strange paths (e.g. zig-zagging or curved paths) to avoid puddles, and taxis and buses might pull over in unusual locations to avoid drop offs in big puddles. In this regard, severity values may be used to adjust the estimated confidence in behavior predictions for other moving objects. In this regard, for deeper, more severe puddles or those with higher severity values, the estimated confidences in predicted behaviors may be reduced as compared to typical situations without any puddles. In addition to vehicles avoiding or slowing for deep puddles, they may hydroplane. The behavior prediction models may be used to estimate a risk factor for them losing control based on vehicle size (proxy for weight/tire size), speed and one or more severity values for a puddle.

In addition, details about puddles can be sent to a remote computing device, such as server computing devices 410 or another computing device, for use. For example, a vehicle may report such information to a dispatching server computing device. As an example, if one vehicle of the fleet recently passed through an area without detecting (and reporting) a puddle of a certain severity value and another vehicle passes through the area and detects (and reports) a puddle of a much higher severity value, the server computing devices 410 could flag the puddle for immediate manual review. This may occur in situations in which a fire hydrant is opened up or during flash flooding events from rain. In some examples, the server computing devices 410 can build a map of puddles, puddle depth and/or puddle severity using severity values. In some instances, cross validation can be achieved by comparing detections of the same puddle from multiple vehicles to build up a more accurate map. In addition, the map may be used to make deployment decisions in order to avoid areas with too many puddles having high severity values. This map may also be shared with vehicles of a fleet of autonomous vehicles, such as vehicles 100A and 100B, in order to better enable those vehicles to avoid puddles, and especially deeper or more severe puddles. In this regard, the map may be used when determining a route between two locations and when selecting pick up and drop off locations at the vehicle.

The above approach may be especially useful at higher speeds, e.g. speeds great enough to cause large, readily observable splashes. However, when vehicles are driving at low speeds such as 5 or 10 miles per hour, not much of a splash may be produced. For example, referring to FIG. 6, if vehicle 670 is driving at a relatively low speed, any splash from the puddle 680 may be very small or even imperceptible to the perception system 172. In such cases a third classifier may be used. In this regard, as noted above, if the first classifier does not detect a splash, for example because the number of LIDAR sensor data points that were filtered as belonging to a splash is below a certain threshold, or if another vehicle passing through a puddle is moving at a vehicle slow speed (e.g. less than 10 miles per hour), the computing devices 110 may utilize the third classifier. Alternatively, the computing devices 110 may select between the first classifier and the third classifier based on a speed of a vehicle passing through a puddle (e.g. the speed of vehicle 670 as it passes through puddle 680).

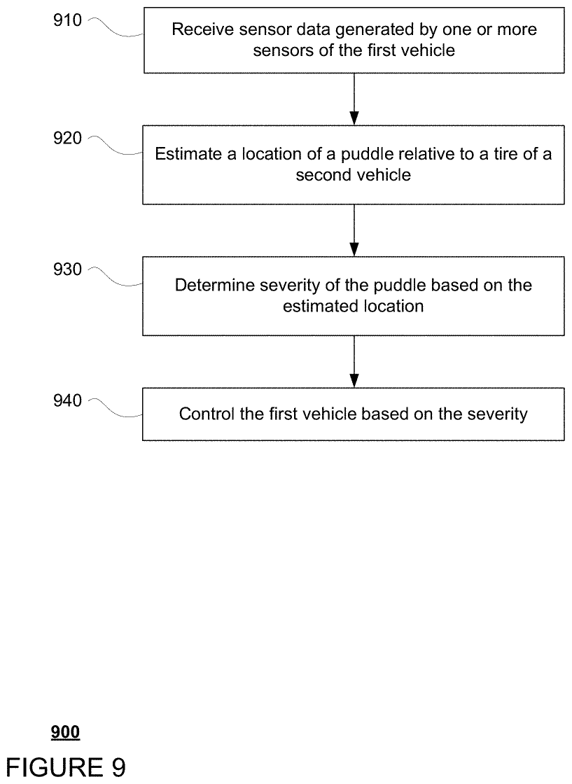

FIG. 9 includes an example flow diagram 900 of some of the examples for controlling a first vehicle, such as vehicle 100, having an autonomous driving mode, which may be performed by one or more processors such as processors of computing devices 110 and/or processors of the positioning system 170. For instance, at block 910, sensor data generated by one or more sensors of the first vehicle is received. For example, the sensors of the perception system 172 may detect and identify objects in the vehicle's environment. Such objects may include the puddle 680 and vehicle 670 of FIG. 6.

At block 920, a location of a puddle relative to a tire of a second vehicle is determined. For example, the third classifier may be trained to identify the center of tires of other vehicles, for instance using computer vision approaches, and the classifier could be used to determine where the top of the puddle is located relative to the tire. The location relative to the tire may be estimated using a default model of a tire (e.g. default shape and dimensions) or even by processing an image of the tire to determine how much of the curvature of the tire is visible in the image. In this regard, the image of the tire must include at least some portion of the lateral side of the tire. In some instances, the classifier may be more advanced and may even take into account the size and shape of different vehicles when determining the location of the top of the puddle relative to the tire. For example, given a vehicle detected as belonging to a particular vehicle class, like passenger or light truck, the classifier could assume nominal tire dimensions, like outer diameter or rim to tread distance. The puddle depth could then be estimated by comparing an exposed part of the tire to the bottom, submerged portion, getting a percent difference between the two, and multiplying that by the characteristic length for that vehicle class.

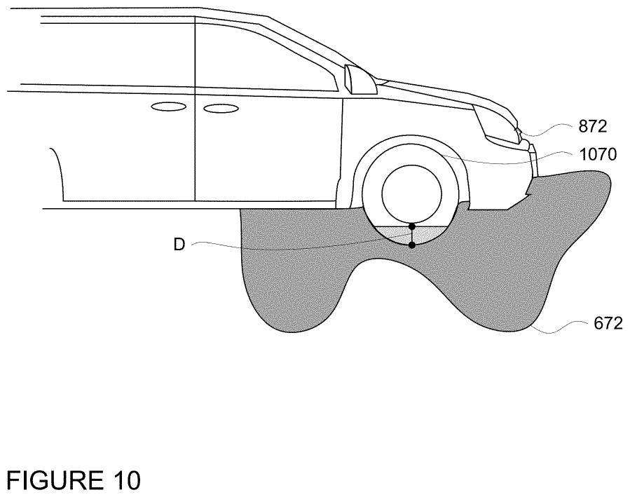

FIG. 10 depicts a detail view of an example of a portion of vehicle 672 and puddle 682. In this example, the tire 872 of the vehicle 672 has caused a very little splash from the puddle, but the tire 1070 is partially submerged in the puddle 682. As can be seen, a portion 1072 of the tire has been submerged. The depth of this submersion, or the distance D may be determined using a default model of a tire or based on a more sophisticated model based on the size and shape of the vehicle 672 described above. In some instances, if there is fine enough resolution sensor data, for example LIDAR sensor data from a LIDAR sensor or a high-resolution image from a camera, the computing devices 110 may be able to measure a tire directly. For example, the computing devices may use the LIDAR sensor data and/or camera image to measure the width of the tire and compare that to the height of the tire. In this regard, a simple approach would assume the exposed tire height +D to be approximately equal to the tire width (not accounting for tire deformation due to vehicle load and driving).

At block 930, severity of the puddle is determined based on the estimated location. For instance, if the tire is determined to be submerged beyond a threshold depth, a severity or depth estimation can be assigned to an observed puddle. This threshold depth may be adjusted based on vehicle speed. For example, as noted above, detecting even 3-5 mm of water at higher vehicle speeds could warrant reducing speed or increasing following distance and thus the threshold depth may be lower for higher speeds. Similarly, 3-5 mm of water at lower vehicle speeds may not actually affect the vehicle, and thus, the threshold depth may be higher at lower speeds. At the same time, deeper puddles that approach the vehicle's ground clearance should be avoided regardless of speed, especially since such puddles could be hiding or obscuring debris or potholes. At block 940, the vehicle is controlled based on the severity. Once a puddle is detected and its severity or depth estimated, such information may be used to control the vehicle as described above. The detection of a puddle and its severity or depth may also be used by other systems of the vehicle as described above. In addition, details about puddles can be sent to a remote computing device, such as server computing devices 410 or another computing device, for use as described above.

When there are no other vehicles around to generate splashes or determine the relative location of a tire with respect to a puddle, the height of the laser points can be compared to the expected height of the road surface based on an elevation map or rather, elevation information of the map data. The difference can be used to estimate puddle depth and/or severity. For instance, immediately after it has rained or during a rain puddles can be detected using a camera or with a LIDAR sensor by identifying reflected points that are dimmer than expected on the road surface. Using this information, an estimation of the puddle's area can be determined and compared to the elevation map. For example, the depth of a puddle may be determined by the computing device 110 by comparing received signal locations around the puddle with map information indicating the height of the lowest road surface within the standing water. For instance, and the surface of a puddle may form a substantially straight line relative to the ground. As such, the computing device 110, may retrieve the elevation of the road surface from the map information, at the location where the received LIDAR signals indicate the puddle starts and ends. The computing device 110 may then identify the lowest elevation or lowest point of the road surface between the starting and end points, from the map information. The elevation of the lowest point may then be subtracted from the elevation of the surface of the puddle to determine the depth of the puddle.

The features described herein may provide for a useful way to detect the depth and also severity of puddles. Being able to route around deep puddles can reduce likelihood that the vehicle encounters a loss of friction, unexpected pothole, mechanical issue due to excessive water exposure (stalling), splashes its own sensors, etc. In addition, the vehicle may be able to prevent itself from being splashed by another vehicle or from splashing another road user such as a pedestrian, etc.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for controlling a first vehicle having an autonomous driving mode, the method comprising:
receiving, by one or more processors, sensor data generated by one or more sensors of the first vehicle;
detecting, by one or more processors, a splash and characteristics of the splash from the sensor data using a classifier;
determining, by one or more processors, severity of a puddle based on the characteristics of the splash and a speed of a second vehicle that caused the splash; and
controlling, by one or more processors, the first vehicle based on the severity.

2. The method of claim 1, wherein the severity corresponds to depth of the puddle where the splash was made.

3. The method of claim 1, wherein the characteristics of the splash include dimensions of the splash.

4. The method of claim 1, wherein the characteristics of the splash include an estimated volume of water over a period of time during the splash.

5. The method of claim 1, wherein determining the severity is further based on a size of the second vehicle.

6. The method of claim 1, further comprising, prior to determining the severity, selecting the classifier from a plurality of options for determining puddle severity based on the speed of the second vehicle.

7. The method of claim 1, wherein controlling the first vehicle includes controlling the first vehicle through the puddle.

8. The method of claim 1, wherein controlling the first vehicle includes controlling the first vehicle to avoid the puddle.

9. The method of claim 1, wherein controlling the first vehicle includes controlling the vehicle in order to avoid splashing the one or more sensors of the first vehicle.

10. The method of claim 1, wherein controlling the first vehicle includes controlling the vehicle in order to avoid splashing another road user.

11. The method of claim 10, wherein the another road user is a third vehicle.

12. The method of claim 10, wherein the another road user is a pedestrian.

13. The method of claim 1, further comprising, prior to detecting the splash, detecting a puddle, and wherein detecting the splash is in response to the detection of the puddle.

14. The method of claim 1, further comprising, sending the severity to a remote computing device.

15. The method of claim 1, wherein the severity corresponds to a severity value for at least one of a severity to the first vehicle, a severity to an object in the first vehicle's environment, or a severity to a passenger of the first vehicle.

16. A method for controlling a first vehicle having an autonomous driving mode, the method comprising:
receiving, by one or more processors, sensor data generated by one or more sensors of the first vehicle;
estimating, by the one or more processors, a location of a puddle relative to a tire of a second vehicle;
determining, by the one or more processors, severity of the puddle based on the estimated location; and
controlling, by the one or more processors, the first vehicle based on the severity.

17. The method of claim 1, further comprising, prior to estimating the severity of the puddle, determining the speed of the second vehicle, and wherein estimating the severity is in response to the determined speed.

18. The method of claim 16, wherein the severity corresponds to a depth of the puddle.

19. The method of claim 16, wherein estimating the severity of the puddle includes determining whether the tire is submerged in the puddle beyond a threshold depth.

20. The method of claim 16, wherein estimating the location of a puddle relative to a tire of the second vehicle is further based on at least one of size or shape of the second vehicle.
